(19) United States
(12) Patent Application Publication
(10) Pub. No.: US 2022/0412492 A1
(43) Pub. Date: Dec. 29, 2022

(54) Coupler for Connecting Flexible Hoses

(71) Applicant: Paul M. Jordan, New Iberia, LA (US)

(72) Inventor: Paul M. Jordan, New Iberia, LA (US)

(21) Appl. No.: 17/362,477

(22) Filed: Jun. 29, 2021

(51) Int. Cl. F16L 33/24

(52) U.S. Cl. CPC F16L 33/24

(57) ABSTRACT

An improved coupler for connecting flexible hoses and tubing has a coupler connecter and an integrated longitudinally extending insert spear. The insert spear is provided with an array of spiraled woodscrew-type threads. The threads of the array of spiraled threads are preferably sharp and coarsely pitched to readily engage the interior sidewall of the internal bore of a hose or tubing segment. Rotation of the insert spear with the spiraled threads will draw the insert spear fully into the internal bore of the tubing segment. The improved coupler may be provided with at least one radial band positioned around the insert spear that serves to seal the internal bore of the tubing segment and hold the insert spear in place.

### FIELD OF INVENTION

The present invention relates to couplers and fittings for linking lengths of flexible tubing and hoses used for conveyance of fluids. In particular, the invention relates to a coupler having an insert spear with woodscrew-type threads that may be readily inserted into the internal bore of flexible tubing and hoses. The coupler of the present invention is especially useful in making a temporary repair of such broken tubing and hoses in remote locations.

### BACKGROUND OF INVENTION

The operation of vehicles, boats, and other power equipment typically utilize flexible tubing and hoses for fluid lines such as vacuum lines, oil lines, fuel lines, water lines, and the like. Such equipment is often used at remote field locations and waterways where replacements for broken hoses and tubing are not readily available. When an equipment hose ruptures or breaks in such a location, and a replacement hose is not available, the broken hose must be repaired in order to make its associated equipment operational. A coupler is often used to repair the broken hose by joining the ends of broken hose segments. A variety of hose couplers or fittings have been provided to repair such broken hoses and tubing.

Many of the provided couplers have an insert neck or spear with one or more radial bands, with or without a barbed shoulder, around the outer or exterior circumference of the insert spear. The radial bands are provided to seal the internal bore around the insert spear and prevent the insert spear from being removed from the hose once the insert spear is in place. To make a repair with such couplers, the coupler insert spear must be inserted into the interior bore of a segment of the broken hose so that the radial bands around the insert spear are forced, i.e., bayonet fitted, into the internal bore of the hose segment against its interior sidewall. In some cases, the coupler is provided with a collar, or a collar and collet combination, that is positioned around the exterior circumference surface of the hose segment in order to force the inserted spear against the interior sidewall of the tubing bore to help hold the insert spear within the internal bore of the hose segment. Examples of such coupler inserts employing externally banded insert spears are shown in U.S. Pat. No. 1,298,294 of Patty, U.S. Pat. No. 6,325,425 of Kierath et al., U.S. Pat. No. 7,661,721 B2 of Mittersteiner, el al., and U.S. Pat. No. 7,922,212 of Werth.

The problem with coupler inserts that employ an insert spear with such bands is that it is often difficult to fully push the insert spear into the internal bore of a hose or tubing segment by hand. Full insertion of the insert spear often requires the use some type of tool, such as pliers or a wrench, to turn the insert spear and force it into the internal bore of the hose. Even when an insertion tool is used, full insertion of the insert spear into the internal bore of a hose segment is often not possible or is too difficult to achieve and the insert spear of the coupler is left only partially inserted into the internal bore of the hose. Partial insertion of the insert spear of a coupler is common particularly when a repair must be made at a remote field location where the necessary insertion tools may not be available. Such partial insertion of the insert spear will often lead to another hose failure.

Consequently, there is a need for a coupler where the full length of its insert spear may be readily inserted into the internal bore of a flexible tube or hose.

There is also a need for a coupler having an insert spear that may be fully inserted into the internal bore of a flexible tube or hose with only minimal use of insertion tools such as pliers or wrenches.

There is also a need for a coupler having an insert spear that may be fully inserted into the internal bore of a flexible tube or hose without the use excessive force.

There is also a need for a coupler having an insert spear that is adaptable for use with a variety of different types of couplers for a flexible tube or hose including garden hose coupler.

There is also a need for a coupler having an insert spear that will threadedly grab the interior sidewall of a flexible tube or hose to facilitate its full insertion into the internal bore of the tube or hose.

There is also a need for a coupler having an insert spear with radial bands, with or without barbed shoulders, around its exterior surface that is adapted to allow the radial bands to be fully inserted into the internal bore of a flexible tube or hose.

### SUMMARY OF THE INVENTION

The present invention is an improved coupler designed to address the aforementioned needs. The improved coupler has a coupler connecter with a central connector bore at its proximal end and a cylindrical insert spear that extends longitudinally to its distal end. The insert spear has a central spear bore in fluid communication with the central connector bore of the coupler connecter. The coupler connector of the improved coupler may be any type of connector such as a female connector provided with internal threads for connection to an externally threaded male coupler or a male connector with external threads for connection to an internally threaded female coupler.

The cylindrical insert spear of the improved coupler has an exterior surface with an array of spiraled, coarsely pitched, preferably sharp “woodscrew-type” threads. These spiraled threads extend along a desired length of the insert spear from the distal end of the improved coupler. When the insert spear of the coupler is inserted into the internal bore of a flexible tube or hose, the spiraled woodscrew-type threads on the exterior of the insert spear are readily engageable with interior sidewall of the internal bore of the flexible tube or hose. When the coupler insert spear is rotated, the spiraled threads on the insert spear engage the sidewall of the flexible hose or tube and draw the insert spear into the internal bore of the flexible tube or hose.

In alternate embodiment, the insert spear of the improved coupler will have a longitudinally extending array of spiraled “woodscrew-type” threads at its insert or distal end and at least one radial band, with or without a barbed shoulder, between the array of spiraled threads and the coupler connector at its coupler or proximal end. The rotation of the coupler insert spear and the array of spiraled threads will draw the insert spear with the radial band fully into the internal bore of the flexible tube or hose.

The insert spear of the improved coupler may also be provided with a turn-ring having a flat nut surface to facilitate turning the insert spear of the improved coupler with a tool such as a wrench or a pair of pliers. The insert spear of the improved coupler may also be provided with a turn-ring having radially extending winged or wingnut-like turning keys that are used to facilitate turning the insert spear of the improved coupler by hand.

The length and diameter of the insert spear of the improved coupler and the pitch or spacing of the spiraled threads on its external surface may be modified as desired depending upon the size and type of the flexible tube or hose with which it is being used. It is thought that minimizing pitch or spacing of the spiraled threads in the range of 3 to 6 threads per inch will provide satisfactory results for a typical garden hose without unduly deforming or damaging the interior bore of the hose. However, the number of threads per inch may vary depending upon the thickness of the sidewall and the internal bore diameter of the hose or tubing with which the coupling will be used. It is thought that the pitch or spacing of the spiraled threads per inch will be increased as the internal diameter of the hose or tubing with which the coupling will be used is decreased and decreased as the internal diameter of the hose or tubing with which the coupling will be used is increased.

The spiraled threads on the external surface of the insert spear may be pointed or the spiraled threads may be rounded, blunted, or flattened depending upon the intended purpose of the tubing or hose with which the improved coupler will be utilized, the thickness of the hose or tubing sidewalls, and its internal bore diameter. Pointed spiraled threads may be more suitable for a tube and hose having a thick sidewall while blunted spiral threads may be more suitable for a tube and hose having a narrow internal bore or a thin sidewall.

These and other objects, advantages, and features of this invention will be apparent to those skilled in the art from a consideration of this specification, the claims and the drawings.

### DESCRIPTION OF THE DRAWINGS

FIG. 1 is a side view of an embodiment of the improved coupler for flexible hoses and tubing of the present invention.

FIG. 2 is a cross-sectional view of the embodiment of the improved coupler for flexible hoses and tubing shown in FIG. 1.

FIG. 3 is a schematic view illustrating the mating of the embodiment of the improved coupler for flexible hoses and tubing shown in FIG. 1 with a hose segment.

FIG. 4 is a side view of another embodiment the improved coupler for flexible hoses and tubing of the present invention.

FIG. 5 is a cross-sectional view of the embodiment of the improved coupler for flexible hoses and tubing shown in FIG. 4.

FIG. 6 is a side view of still another embodiment the improved coupler for flexible hoses and tubing of the present invention.

FIG. 7 is a schematic view of the insertion of the embodiment of the side view of the improved coupler shown in FIG. 6 inserted into the internal bore of a flexible hose.

FIG. 8 is a schematic view illustrating the mating of adjoining hose segments with embodiments of the improved coupler for flexible hoses and tubing of the present invention having corresponding male and female coupler connectors having winged turning keys.

### DESCRIPTION OF THE EMBODIMENTS

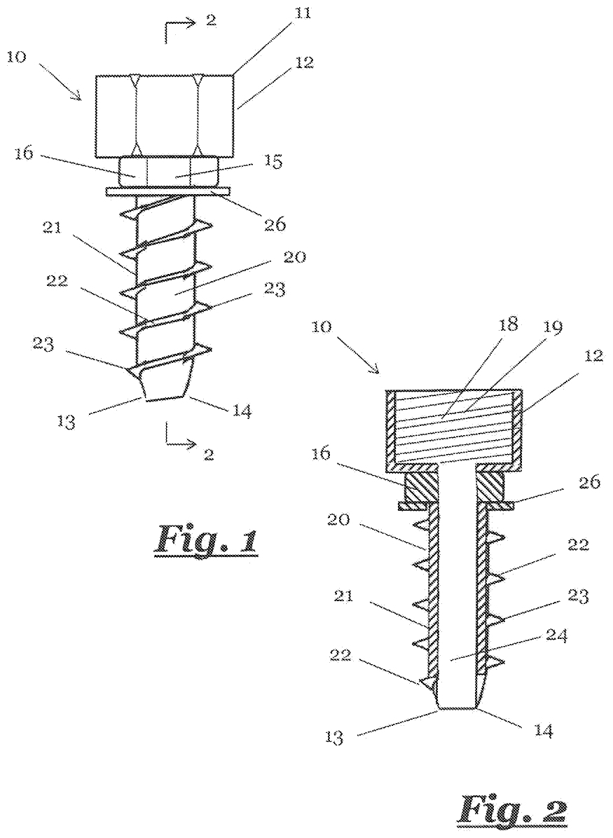

FIG. 1 is a side view of an embodiment of the improved coupler (10) for flexible hoses and tubing designed to address the aforementioned needs. The improved coupler (10) has a proximal end (11) and a distal end (13). A threaded coupler connecter (12), shown as a female coupler connector having internal threads (19), is positioned at the proximal end (11) of the improved coupler (10) and a longitudinally extending cylindrical insert spear (20) extends from the threaded coupler connecter (12) to the distal end (13) of the improved coupler (10).

The longitudinally extending insert spear (20) has a point (14) at its distal end (13) and an exterior surface (21) with an array of spiraled “woodscrew-type” threads (22). These spiraled threads (22) extend from the distal end (13) toward the proximal end (11) of the improved coupler (10) along a desired length of the insert spear (20). The spiraled threads (22) are shown as having pointed thread peaks (23) for purposes of illustration but the thread peaks (23) of the spiraled threads (22) may be rounded, blunted, or flattened as well as pointed depending upon the wall thickness and intended purpose of the tubing or hose with which the improved coupler will be utilized. The length and the external diameter of the insert spear (20) and the spacing of the spiraled “woodscrew-type” threads (22) on its external surface may be modified as desired depending upon the size and type of the flexible tube or hose with which coupler (00) is being used and the desired length of the array of spiraled threads (22).

It is thought that a coupler (10) having an insert spear (20) with coarsely spiraled threads (22) having a pitch or spacing in the range of 3 to 6 threads per inch will provide satisfactory results for a tube or hose having an internal bore diameter in the range of ⅜ inches to ¾ inches such as that of a typical garden hose. It is also thought that for a coupler (10) having an insert spear (20) with spiraled threads (22) utilized with hose or tubing having an internal diameter less than ⅜ths of an inch, the number of spiraled threads (22) per inch will be increased.

The insert spear (20) may be provided with a turn-ring (16) having a flat nut surface (15) to facilitate turning the insert spear of the improved coupler with a tool such as a wrench. A washer (26) distal from the turn-ring (16) may be provided to seal on the internal bore (25) of a flexible hose or tube (27). The turn-ring (16) and washer (26) may be separate elements or combined as a one-piece element. As shown in FIG. 2, a cross-section view cut along lines 2-2 of FIG. 1, the threaded coupler connecter (12) has a central bore (18) in fluid communication with a central spear bore (24) within the insert spear (20).

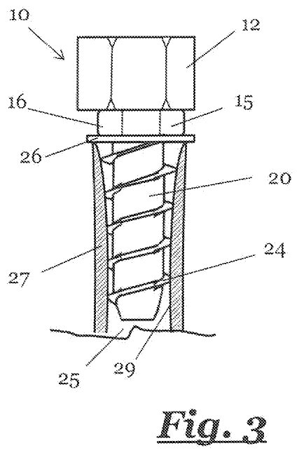

FIG. 3 shows a schematic view illustrating the mating of the improved coupler (10) shown in FIG. 1 within the interior bore (25) of a flexible hose segment (27). When the insert spear (20) of the improved coupler (10) is inserted into the bore (25) of flexible hose segment (27) and rotated, the array of spiraled, pointed threads (24) readily engages with interior sidewall (29) of the internal bore (25) of the flexible hose segment (27). When the insert spear (20) is so rotated, the insert spear (20) is drawn further into the bore (25) until the hose segment (27) engages the washer (26) to seal the bore (25) of the hose segment (27).

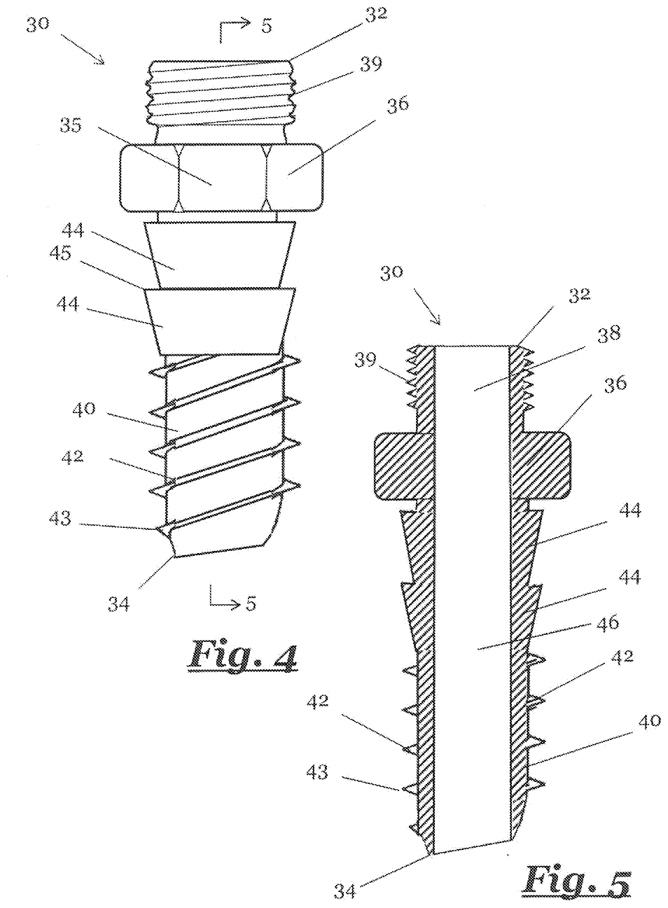

FIG. 4 shows coupler (30), another embodiment the improved coupler for flexible hoses and tubing of the present invention. Coupler (30) has an externally threaded male coupler connector (32) with external threads (39) to correspond with the internal threads of a female coupler connector, such as internal threads (19) of female coupler connector (12) as shown in FIG. 1-FIG. 3.

Coupler (30) has a proximal end (31) and a distal end (33). The threaded coupler connecter (32) is positioned at the proximal end (31) of the coupler (30) and a longitudinally extending cylindrical insert spear (40) extends from the threaded coupler connecter (32) to the distal end (33) of coupler (30). The longitudinally extending insert spear (40) has an exterior surface (41) having an array of spiraled woodscrew-type” threads (42) as described for threads (22) shown in FIGS. 1-3.

The spiraled threads (42) are shown as having pointed thread peaks (43) for purposes of illustration but the thread peaks (43) of the spiraled threads (42) may be rounded, blunted, or flattened as well as pointed depending upon the wall thickness and intended purpose of the tubing or hose with which the improved coupler will be utilized. These spiraled threads (42) on the insert spear (40) extend from the distal end (33) of insert spear (40) toward the proximal end (31) of coupler (30) along a desired length of the insert spear (40). As shown in FIG. 5, a cross-section view cut along lines 5-5 of FIG. 4, the threaded coupler connecter (32) has a central bore (38) in fluid communication with a central connector bore (46) in the insert spear (40).

Coupler (30) may also have at least one radial band (44). As shown if FIGS. 3 and 4, radial band (44) is comprised of a cone-shaped ring having a protruding barbed shoulder (45). Band (44) is positioned on the insert spear (40) proximal from the array of spiraled threads (42). The cone-shaped band (44) serves to prevent removal of the insert spear (40) from the internal bore of a flexible hose and also serves to seal the internal bore of the flexible hose or tube.

The insert spear (40) of coupler (30) may be provided with a turn-ring (36) that may have a flat nut surface (35) to facilitate turning or rotating the insert spear (40) of coupler (30) with a tool such as a wrench or pliers. When the insert spear (40) of coupler (30) is inserted into the internal bore of a flexible hose or tubing, rotation of the insert spear (40) and the spiraled threads (42) of coupler (30) will deform the interior sidewall of the internal bore of a tube or hose and readily draw the insert spear (40) and the cone-shaped band (44) into and through the internal bore of the flexible hose or tubing.

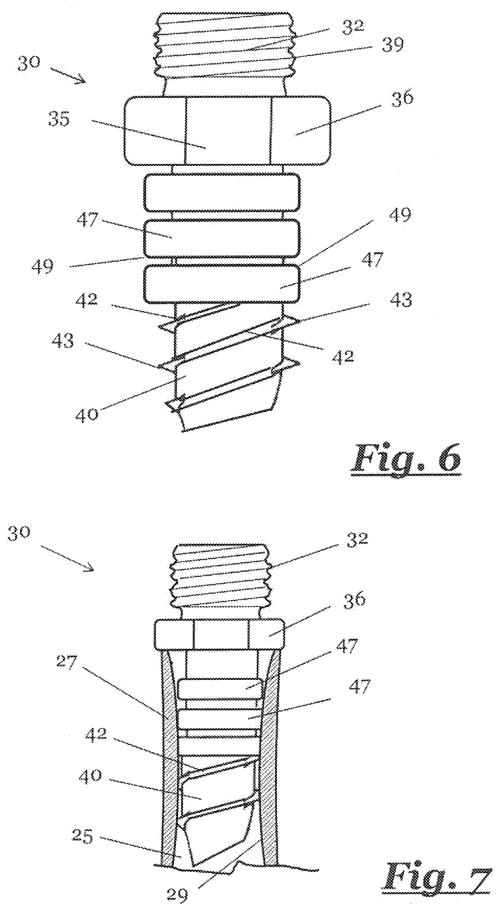

As shown in FIG. 6, coupler (30) may also have one or more radial bands (47) in place of the cone-shaped bands (44) shown in FIGS. 4 and 5. The radial bands (47) have rounded shoulders (49) that facilitate insertion of the bands (47) into internal bore of a flexible hose. The radial bands (47) serve to impede removal of the insert spear (40) from the internal bore of a flexible hose and also serve to seal the internal bore of the flexible hose or tube.

FIG. 7 is a schematic illustration showing the insertion of coupler 30 having radial bands (47) as shown in FIG. 6 that are inserted into the internal bore (25) of a flexible hose segment (27). When the insert spear (40) of coupler (30) shown in FIG. 6 is inserted into the internal bore (25) of the flexible hose segment (27), rotation of the insert spear (40) and the spiraled threads (42) of coupler (30) engages and deforms the sidewall (29) of the internal bore (25) and draws the entire length of the insert spear (40) with the radial bands (47) into and through the internal bore (25) and thereby fixes the insert spear (40) of the coupler (30) fully within the hose segment (27) to seal its internal bore (25).

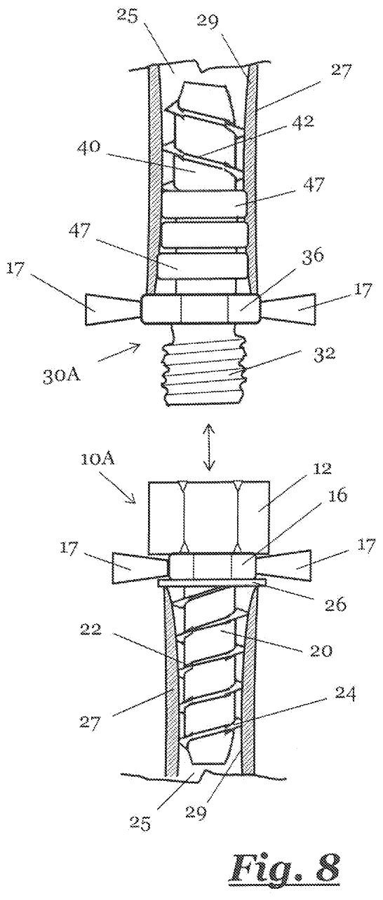

FIG. 8 is a schematic view of one example of the mating of adjoining hose segments (27) with embodiments of the improved coupler for flexible hoses and tubing of the present invention. In the illustration of FIG. 8, a coupler (10A) is being mated with a coupler (30A). Coupler (10A) has all of the features of coupler (10) shown in FIGS. 1-3. However, the turn-ring (16) is provided with radially extending winged turning keys (17) in addition to or in lieu of flat nut surface (15). The winged turning keys (17) of turn-ring (16) are used to facilitate turning the insert spear (20) by hand. If desired, coupler (10A) may be also provided with beveled collet ring (51) positioned around the outside perimeter of the hose segment (27) that engages with a corresponding collet sleeve (53) to compress the hose segment (27) to aid in securing coupler (10A) within the internal bore (25) of the hose segment (27).

Coupler (30A), as shown in FIG. 8, has the features of coupler (30) shown in FIGS. 6 and 7. However, turn-ring (36) is provided with radially extending winged turning keys (17). The winged turning keys (17) of turn-ring (36) are used to facilitate turning the insert spear (40) by hand to push the radial bands (47) of the insert spear (40) into the internal bore (25) of the hose segment (27).

The embodiments of the improved coupler of Applicant's invention described herein are intended to be illustrative but not limiting. Variations and changes may be made to the described embodiments without departing from the spirit and scope of the invention as defined in the following claims.

I claim:

1. An improved coupler for flexible hoses and tubing comprising:
(a) coupler connecter;
(b) a longitudinally extending insert spear; and
(c) an array of spiraled woodscrew-type threads positioned along said longitudinally extending insert spear.

2. The improved coupler for flexible hoses and tubing recited in claim 1 wherein said coupler connector has a central bore in fluid communication with a central connector bore within said insert spear.

3. The improved coupler for flexible hoses and tubing recited in claim 2 further comprising a turn-ring whereby said insert spear may be rotated.

4. The improved coupler for flexible hoses and tubing recited in claim 3 wherein said array of spiraled woodscrew-type threads having a pitch in the range of 3 to 8 per inch.

5. The improved coupler for flexible hoses and tubing recited in claim 4 wherein said coupler connecter is a threaded connector.

6. The improved coupler for flexible hoses and tubing recited in claim 5 wherein said threads in said array of spiraled woodscrew-type threads are pointed threads.

7. The improved coupler for flexible hoses and tubing recited in claim 6 wherein said turn-ring has radially extending winged turning keys.

8. The improved coupler for flexible hoses and tubing recited in claim 7 further comprising at least one radial band positioned around said insert spear between said coupler connector and said array of spiraled woodscrew-type threads.

9. The improved coupler for flexible hoses and tubing recited in claim 4 wherein said threads in said array of spiraled woodscrew-type threads are rounded threads and wherein said coupler connecter is a threaded connector.

10. The improved coupler for flexible hoses and tubing recited in claim 9 wherein said turn-ring has radially extending winged turning keys.

11. An improved coupler for flexible hoses and tubing comprising:
(a) coupler connecter, said coupler having a central connector bore;
(b) a longitudinally extending insert spear, said insert spear having a having a central spear bore in fluid communication with said central connector bore; and
(c) an array of spiraled woodscrew-type threads positioned along said longitudinally extending insert spear.

12. The improved coupler for flexible hoses and tubing recited in claim 11 further comprising a turn-ring whereby said insert spear may be rotated.

13. The improved coupler for flexible hoses and tubing recited in claim 12 wherein said array of spiraled woodscrew-type threads have a pitch in the range of 3 to 8 per inch.

14. The improved coupler for flexible hoses and tubing recited in claim 13 wherein said coupler connecter is a threaded connector.

15. The improved coupler for flexible hoses and tubing recited in claim 14 further comprising at least one radial band positioned around said insert spear between said coupler connector and said array of spiraled woodscrew-type threads.

16. The improved coupler for flexible hoses and tubing recited in claim 15 wherein said turn-ring has a radially extending winged turning key.

17. The improved coupler for flexible hoses and tubing recited in claim 13 wherein said array of spiraled woodscrew-type threads have threads selected from the group consisting of rounded threads, pointed threads, flattened threads, and blunted threads.

18. The improved coupler for flexible hoses and tubing recited in claim 17 further comprising a turn-ring whereby said insert spear may be rotated.

19. The improved coupler for flexible hoses and tubing recited in claim 18 wherein said coupler connecter is a threaded connector.

20. The improved coupler for flexible hoses and tubing recited in claim 19 further comprising at least one radial band positioned around said insert spear between said coupler connector and said array of spiraled woodscrew-type threads.
